(19) United States
(12) Patent Application Publication
(10) Pub. No.: US 2026/0067554 A1
(43) Pub. Date: Mar. 5, 2026

(54) IMAGE CAPTURING APPARATUS, SYSTEM, ADAPTER, CONTROL METHOD, AND STORAGE MEDIUM

(71) Applicant: CANON KABUSHIKI KAISHA, Tokyo (JP)

(72) Inventors: YUSUKE YAMASHITA, Kanagawa (JP); KENTO WATANABE, Kanagawa (JP); TAKAHIRO KAMIKURA, Tokyo (JP)

(21) Appl. No.: 19/313,649

(22) Filed: Aug. 28, 2025

(30) Foreign Application Priority Data
Sep. 5, 2024 (JP) 2024-153334

(51) Int. Cl. H04N 23/60; G03B 17/56

(52) U.S. Cl. CPC H04N 23/60; G03B 17/56

(57) ABSTRACT

There is provided an apparatus having a first contact unit and a second contact unit. A first communication unit performs first communication via the first contact unit. A second communication unit performs second communication via the first contact unit. A detection unit detects a voltage of the second contact unit after a respective accessory among a plurality of accessories has been connected. A control unit performs control to start the second communication in a case where the detected voltage of the second contact unit satisfies a first condition. The predetermined adapter is configured to, when connected to the apparatus, provide the second contact unit with a voltage that satisfies the first condition.

### BACKGROUND

### Field of the Technology

The aspect of the embodiments relates to an image capturing apparatus, a system, an adapter, a control method, and a storage medium.

### Description of the Related Art

Interchangeable-lens camera systems, in which lenses are attachable/removable and interchangeable, have become widespread. In such systems, a camera obtains lens information by mutually communicating with an interchangeable lens mounted thereon; as a result, appropriate control can be performed with respect to the interchangeable lens, and a user can be notified of the lens information as a result of displaying the lens information on a monitor of the camera.

Also, there is a case where an adapter is mounted between a camera and an interchangeable lens. For example, there are adapters that convert a mount so as to enable mounting of a lens that has a different mount shape and cannot be mounted directly on a camera (mount conversion adapters), and so forth. In this case, command transmission from a camera to an interchangeable lens, and data transmission from an interchangeable lens to a camera, are performed via an adapter.

Japanese Patent Laid-Open No. 2019-3208 discloses a system that, in a case where an intermediate accessory like an adapter is mounted between a camera and an interchangeable lens, includes a channel for performing camera-lens communication and a channel for performing camera-adapter communication.

Also, Japanese U.S. Pat. No. 6,360,261 discloses a lens system technique that, after an intermediate accessory has been recognized based on the polarity of a specific terminal, switches between camera-interchangeable lens data communication and interchangeable lens-intermediate accessory data communication in accordance with the polarity of the specific terminal.

In a case where an adapter is mounted between a camera (an image capturing apparatus) and an interchangeable lens, there is a possibility that an interchangeable lens mounted on the camera via the adapter does not support the communication standard between a camera and an interchangeable lens that is for an interchangeable lens directly mountable on a camera, and supports a different communication standard.

### SUMMARY

According to a first aspect of the embodiments, there is provided an apparatus, comprising: a first contact unit and a second contact unit for use in connecting each of a plurality of accessories, including a predetermined adapter, to the apparatus; and at least one processor and at least one memory coupled to the at least one processor storing instructions that, when executed by the at least one processor, cause the at least one processor to function as: a first communication unit configured to perform first communication via the first contact unit; a second communication unit configured to perform second communication via the first contact unit; a detection unit configured to detect a voltage of the second contact unit after a respective accessory among the plurality of accessories has been connected; and a control unit configured to perform control to start the second communication in a case where the detected voltage of the second contact unit satisfies a first condition, wherein the predetermined adapter is configured to, when connected to the apparatus, provide the second contact unit with a voltage that satisfies the first condition, the predetermined adapter includes a third contact unit for use in connecting a predetermined interchangeable lens, which supports the second communication, to the predetermined adapter, and the predetermined adapter includes a communication path that causes the second communication from the apparatus to reach the third contact unit.

According to a second aspect of the embodiments, there is provided a system, comprising: the apparatus according to the first aspect; and the predetermined adapter.

According to a third aspect of the embodiments, there is provided an adapter connectable to an apparatus, wherein the apparatus comprises: a first contact unit; a second contact unit; and at least one processor and/or at least one circuit which functions as: a first communication unit configured to perform first communication via the first contact unit; and a second communication unit configured to perform second communication via the first contact unit, the adapter comprising: a first contact unit configured to be connected to the first contact unit of the apparatus when the adapter has been connected to the apparatus; a second contact unit configured to be connected to the second contact unit of the apparatus when the adapter has been connected to the apparatus; a third contact unit for use in connecting a predetermined interchangeable lens, which supports the second communication, to the adapter; and a communication path configured to cause the second communication from the apparatus to reach the third contact unit, wherein the adapter is configured to, when connected to the apparatus, provide the second contact unit of the apparatus with a voltage that satisfies a first condition via the second contact unit of the adapter.

According to a fourth aspect of the embodiments, there is provided a control method executed by an apparatus, wherein the apparatus comprises: a first contact unit and a second contact unit for use in connecting each of a plurality of accessories, including a predetermined adapter, to the apparatus; and at least one processor and at least one memory coupled to the at least one processor storing instructions that, when executed by the at least one processor, cause the at least one processor to function as: a first communication unit configured to perform first communication via the first contact unit; and a second communication unit configured to perform second communication via the first contact unit, the control method comprising: detecting a voltage of the second contact unit after a respective accessory among the plurality of accessories has been connected; and performing control to start the second communication in a case where the detected voltage of the second contact unit satisfies a first condition, wherein the predetermined adapter is configured to, when connected to the apparatus, provide the second contact unit with a voltage that satisfies the first condition, the predetermined adapter includes a third contact unit for use in connecting a predetermined interchangeable lens, which supports the second communication, to the predetermined adapter, and the predetermined adapter includes a communication path that causes the second communication from the apparatus to reach the third contact unit.

According to a fifth aspect of the embodiments, there is provided a non-transitory computer-readable storage medium which stores a program for causing an apparatus to execute a control method, wherein the apparatus comprises a first contact unit and a second contact unit for use in connecting each of a plurality of accessories, including a predetermined adapter, to the apparatus, the control method comprising: performing first communication via the first contact unit; and performing second communication via the first contact unit, detecting a voltage of the second contact unit after a respective accessory among the plurality of accessories has been connected; and performing control to start the second communication in a case where the detected voltage of the second contact unit satisfies a first condition, wherein the predetermined adapter is configured to, when connected to the apparatus, provide the second contact unit with a voltage that satisfies the first condition, the predetermined adapter includes a third contact unit for use in connecting a predetermined interchangeable lens, which supports the second communication, to the predetermined adapter, and the predetermined adapter includes a communication path that causes the second communication from the apparatus to reach the third contact unit.

Features of the disclosure will become apparent from the following description of embodiments with reference to the attached drawings. The following description of embodiments are described by way of example.

### BRIEF DESCRIPTION OF THE DRAWINGS

FIG. 1 is a block diagram showing a configuration of a camera system according to a first embodiment.

FIG. 2 is a flowchart of startup processing of a camera 100 according to the first embodiment.

FIG. 3 is a block diagram showing a configuration of a camera system according to a second embodiment.

FIG. 4 is a flowchart of startup processing of a camera 100 according to the second embodiment.

FIG. 5 is a block diagram showing a configuration of a camera system according to a third embodiment.

FIG. 6 is a flowchart of startup processing of a camera 100 according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### <Configuration of Camera System>

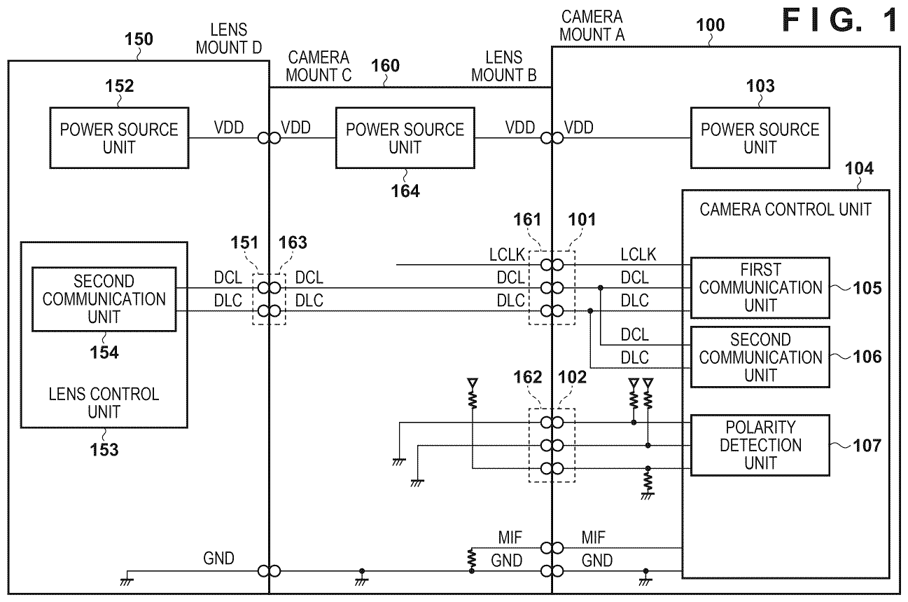

FIG. 1 is a block diagram showing a configuration of a camera system according to a first embodiment. The camera system includes a camera 100 (an image capturing apparatus), an interchangeable lens 150 (an interchangeable lens apparatus), and an adapter 160 (an adapter apparatus) arranged between the camera 100 and the interchangeable lens 150.

The camera 100 includes a camera mount A. The adapter 160 includes a lens mount B connectable to the camera mount A. Therefore, the adapter 160 can be mounted (connected) directly on (to) the camera 100.

Also, the adapter 160 includes a camera mount C, which is different from the camera mount A, at the opposite side of the lens mount B. The interchangeable lens 150 includes a lens mount D connectable to the camera mount C. Therefore, the interchangeable lens 150 can be mounted (connected) directly on (to) the adapter 160.

Unlike the lens mount B, the lens mount D of the interchangeable lens 150 is shaped in such a manner that it cannot be connected to the camera mount A of the camera 100. Therefore, the interchangeable lens 150 cannot be mounted directly on the camera 100, but can be mounted on the camera 100 via the adapter 160. Note that an interchangeable lens including the lens mount B (not shown) can be mounted directly on the camera 100.

### <Functions of Terminals of Camera Mount A and Lens Mount B>

Next, the functions of each terminal common to both of the camera mount A and the lens mount B will be described.

A VDD terminal is a terminal for supplying power from the camera 100 to a camera accessory mounted on the camera 100, mainly as communication power used in communication control. A camera accessory (which may hereinafter be simply referred to as an “accessory”) is a general term for an apparatus, such as an adapter and an interchangeable lens, connectable to a camera mount like the camera mount A, the camera mount C, or the like. For example, the adapter 160 including the lens mount B, an interchangeable lens including the lens mount B (not shown), the interchangeable lens 150 including the lens mount D, and the like are equivalent to a camera accessory.

Note that, hereinafter, the “VDD terminal” may be simply referred to as “VDD” by omitting the notation of “terminal”. In this regard, the same goes for terminals other than the VDD terminal; for example, a later-described “GND terminal” may be simply referred to as “GND”.

A GND terminal is a ground terminal indicating a ground level, which is a reference voltage level corresponding to various types of terminals including the VDD terminal. Although it is referred to as the ground terminal, it can be any terminal that indicates the reference voltage level, and the indicated voltage level may be a level other than the ground level.

An MIF terminal is a terminal for detecting mounting of a camera accessory (e.g., the adapter 160, an interchangeable lens including the lens mount B (not shown), or the like) on the camera 100. The camera 100 detects mounting (connection) of a camera accessory on (to) the camera 100 and detachment (disconnection) of a camera accessory therefrom by detecting a voltage level of the MIF terminal. In the embodiment, the camera 100 determines that an accessory is not mounted in a case where the voltage of the MIF terminal is High (H), and determines that an accessory is mounted in a case where this voltage is Low (L).

An LCLK terminal is a terminal for a clock signal output from the camera 100 to a camera accessory. Furthermore, the LCLK terminal also plays a role as a terminal intended for the camera 100 to monitor a busy state of an accessory.

A DCL terminal is a terminal for communication data output from the camera 100 to a camera accessory.

A DLC terminal is a terminal for communication data output from a camera accessory to the camera 100.

In the embodiment, the LCLK terminal, the DCL terminal, and the DLC terminal are used in later-described first communication. Also, the DCL terminal and the DLC terminal are used in later-described second communication as well, in addition to the first communication.

Note that although the terminals of the camera mount A are contact pins and the terminals of the lens mount B are contact surfaces, it is permissible to adopt a configuration in which their shapes are reversed.

### <Functions of Terminals of Camera Mount C and Lens Mount D>

Next, the functions of each terminal common to both of the camera mount C and the lens mount D will be described.

A VDD terminal is a terminal that supplies power from the camera 100 as power used in control on the interchangeable lens 150. In the embodiment, it is assumed that a voltage supplied to the camera mount C and the lens mount D is 11.0 V.

A GND terminal is a ground terminal indicating a ground level, which is a reference voltage level corresponding to the VDD terminal. Although it is referred to as the ground terminal, it can be any terminal that indicates the reference voltage level, and the indicated voltage level may be a level other than the ground level.

A DCL terminal is a terminal for communication data output from the camera 100 to the interchangeable lens 150.

A DLC terminal is a terminal for communication data output from the interchangeable lens 150 to the camera 100.

In the embodiment, the DCL terminal and the DLC terminal are used in the later-described second communication.

Note that although the terminals of the camera mount C are contact pins and the terminals of the lens mount D are contact surfaces, it is permissible to adopt a configuration in which their shapes are reversed.

### <Configuration of Camera 100>

Next, a configuration of the camera 100 will be described. The camera 100 includes the terminals of the camera mount A, and includes a contact unit 101, a contact unit 102, a power source unit 103, and a camera control unit 104. A first communication unit 105, a second communication unit 106, and a polarity detection unit 107 are provided inside the camera control unit 104.

The contact unit 101 (a first contact unit) is a group of contacts for performing communication controlled by the first communication unit 105 or the second communication unit 106, and is composed of three terminals, namely LCLK, DCL, and DLC.

The contact unit 102 (second contact unit) is a group of contacts intended to detect polarities for judging whether a camera accessory connected to the camera 100 is the adapter 160. In the following description, it is assumed that the contact unit 102 is composed of three terminals. However, the number of terminals included in the contact unit 102 is not particularly limited, and it is sufficient for the contact unit 102 to include one or more terminals.

The power source unit 103 generates power to be supplied to a camera accessory mounted on the camera 100 via VDD. Furthermore, the power source unit 103 also generates power to be supplied to the inside of the camera 100, such as the camera control unit 104.

The camera control unit 104 plays a role in control in the camera 100; for example, it calculates a focus lens driving amount for focus control, generates image data in accordance with a state of a release switch, and so forth. Note that the camera control unit 104 is composed of one or more processors or a circuit (e.g., an ASIC) that realizes one or more functions, and each unit can be controlled by, for example, the processor(s) reading out and executing a program stored in a memory.

The first communication unit 105 performs camera-lens communication (hereinafter referred to as “first communication”) for transmitting a command for an instruction or a request to an interchangeable lens including the lens mount B (not shown), and receiving lens information from the interchangeable lens. As shown in FIG. 1, the first communication unit 105 performs communication using three communication lines corresponding to LCLK, DCL, and DLC in the contact unit 101. The first communication can be performed through, for example, clock synchronous communication or asynchronous communication; however, in the embodiment, it is assumed that the first communication is performed through clock synchronous communication. Also, in the embodiment, the camera 100 is configured so that, in a case where an accessory has been detected using the MIF terminal, communication is performed with the camera accessory using the first communication unit 105 at first.

The second communication unit 106 is a communication unit for performing communication with the interchangeable lens 150 including the lens mount D. The second communication unit 106 performs camera-lens communication (hereinafter referred to as “second communication”) for transmitting a command for an instruction or a request to the interchangeable lens 150, and receiving lens information from the interchangeable lens 150. The second communication is a communication standard capable of communicating with an interchangeable lens that does not support the first communication. As shown in FIG. 1, the second communication unit 106 performs communication using two communication lines corresponding to DCL and DLC in the contact unit 101. Also, the second communication unit 106 performs asynchronous communication of a standard different from the communication standard of the first communication unit 105. In the embodiment, DCL and DLC, which are two terminals in the contact unit 101 used by the first communication unit 105, are also used by the second communication unit 106.

Note that in the specification, in a case where at least a part of terminals inside the contact unit 101 (first contact unit) is used, such expressions as “the contact unit 101 is used” and “via the contact unit 101” are used. Therefore, both of the first communication that uses three terminals of the contact unit 101, and the second communication that uses two terminals of the contact unit 101, are communication in which the contact unit 101 is used (or communication performed via the contact unit 101). In this regard, the same goes for contact units other than the contact unit 101.

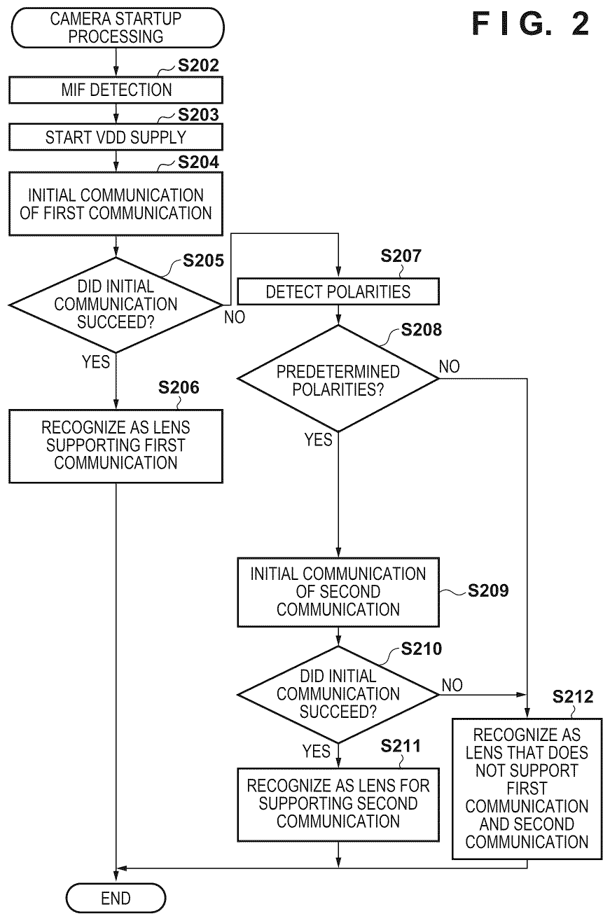

The polarity detection unit 107 detects polarities of voltages of the contact unit 102. The detected polarities are used to judge a type of a camera accessory mounted on the camera 100 (the details will be described later with reference to FIG. 2).

### <Configuration of Interchangeable Lens 150>

Next, a configuration of the interchangeable lens 150 will be described. The interchangeable lens 150 has the lens mount D, and includes a contact unit 151, a power source unit 152, and a lens control unit 153. A second communication unit 154 is provided inside the lens control unit 153.

The contact unit 151 (a third contact unit) is a group of contacts for the second communication with the camera 100, and is composed of two terminals, namely DCL and DLC.

The power source unit 152 supplies a voltage supplied from the adapter 160 via the VDD terminal to, for example, the lens control unit 153 inside the interchangeable lens 150.

The lens control unit 153 plays a role in control in the interchangeable lens 150; for example, it obtains position information of the focus lens (not shown) and information of the diaphragm. Note that the lens control unit 153 is composed of one or more processors or a circuit (e.g., an ASIC) that realizes one or more functions, and each unit can be controlled by, for example, the processor(s) reading out and executing a program stored in a memory.

The second communication unit 154 is a communication unit for performing the second communication with the second communication unit 106 of the camera 100. The second communication unit 154 receives a command from the camera 100, and transmits information of the interchangeable lens 150. As shown in FIG. 1, the second communication unit 154 performs communication using two communication lines corresponding to DCL and DLC in the contact unit 151.

### <Configuration of Adapter 160>

Next, a configuration of the adapter 160 will be described. The adapter 160 has the lens mount B and the camera mount C, and includes a contact unit 161, a contact unit 162, a contact unit 163, and a power source unit 164.

The contact unit 161 (first contact unit) is a group of contacts for the first communication with the camera 100, and is composed of three terminals, namely LCLK, DCL, and DLC. Furthermore, the contact unit 161 is used also for the second communication between the camera 100 and the interchangeable lens 150. The contact unit 161 of the adapter 160 is connectable to the contact unit 101 of the camera 100.

The contact unit 162 (second contact unit) is a contact unit configured to be connected to the contact unit 102 of the camera 100 in a case where the adapter 160 has been mounted on the camera 100. Similarly to the contact unit 102, the number of terminals included in the contact unit 162 is not particularly limited, and it is sufficient for the contact unit 162 to include one or more terminals.

The adapter 160 is configured to, when mounted on the camera 100, provide the contact unit 102 with voltages of predetermined polarities via the contact unit 162. As shown in FIG. 1, among the three terminals included in the contact unit 162, the top and middle terminals are connected to GND, and the bottom terminal is connected to VDD via a resistor. Therefore, in the example of FIG. 1, the adapter 160 is configured to provide the three terminals in the contact unit 102 with voltages of polarities L, L, and H, respectively, from the top. However, the voltages provided by the adapter 160 to the contact unit 102 are not limited to the example of FIG. 1 (the details will be described later with reference to FIG. 2).

The contact unit 163 (third contact unit) is a group of contacts for the second communication between the camera 100 and the interchangeable lens 150, and is composed of two terminals, namely DCL and DLC. The contact unit 163 of the adapter 160 is connectable to the contact unit 151 of the interchangeable lens 150. As shown in FIG. 1, the adapter 160 includes a communication path that causes the second communication from the camera 100 via the contact unit 101 and the contact unit 161 to reach the contact unit 163.

The power source unit 164 transforms power supplied from the camera 100 via the VDD terminal into voltage compatible with the interchangeable lens 150 including the lens mount D, and supplies the power having the transformed voltage.

### <Processing for Starting Camera 100>

FIG. 2 is a flowchart of processing for starting the camera 100 according to the first embodiment. When a user has operated a power source button (not shown) of the camera 100, a power source of the camera 100 is turned ON, and the power source unit 103 starts to supply an operating power; consequently, the camera control unit 104 starts the startup processing of the flowchart. It is assumed that processing of each step in the flowchart is realized by the camera control unit 104 executing a program stored in a ROM (not shown) unless specifically stated otherwise.

In step S202, the camera control unit 104 detects the MIF terminal. In a case where the voltage of the MIF terminal is H, the camera control unit 104 determines that a camera accessory including the lens mount B is not mounted, and continues the detection of the MIF terminal in step S202 until the MIF terminal becomes L. In a case where the voltage of the MIF terminal is L, the camera control unit 104 determines that an accessory including the lens mount B has been mounted, and processing proceeds to step S203.

In step S203, the camera control unit 104 starts to supply a VDD voltage to the accessory.

In step S204, the first communication unit 105 inside the camera control unit 104 performs initial communication of the first communication. A communication method of the first communication unit 105 is a communication method intended for communication with an interchangeable lens that includes the lens mount B. The specification of the startup processing sequence of the camera 100 is configured to, in a case where an accessory has been detected using the MIF terminal, recognize an interchangeable lens that includes the lens mount B via the first communication at first.

In the initial communication of the first communication, the first communication unit 105 transmits, for example, a command for confirmation of communication with an interchangeable lens, a command for obtainment of a lens ID (a command for distinguishing the mounted accessory), and a command for obtaining a focal length, an f-number, and the like.

In a case where an interchangeable lens that supports the first communication is mounted on the camera 100, the camera control unit 104 can distinguish the type of the mounted interchangeable lens by obtaining initial information, a lens ID, and the like of the interchangeable lens via the first communication.

However, in FIG. 1, the adapter 160 is mounted on the camera 100 instead of an interchangeable lens that includes the lens mount B, and the interchangeable lens 150 that does not support the first communication is mounted on the adapter 160. Therefore, the camera control unit 104 cannot obtain a response to a command transmitted from the first communication unit 105, and the initial communication of the first communication fails.

In step S205, the camera control unit 104 judges whether the initial communication of the first communication has succeeded. In a case where the initial communication of the first communication has succeeded, processing proceeds to step S206; otherwise, processing proceeds to step S207.

In step S206, the camera control unit 104 recognizes that the mounted interchangeable lens is a lens that supports the first communication. Thereafter, the startup processing ends, and the operations of the camera control unit 104 transition to a normal sequence of the first communication.

In step S207, the polarity detection unit 107 inside the camera control unit 104 detects the polarity (H or L) of the voltage of each terminal in the contact unit 102.

In step S208, the camera control unit 104 judges whether the polarities detected in step S207 are predetermined polarities. In a case where the detected polarities are the predetermined polarities, processing proceeds to step S209; otherwise, processing proceeds to step S212.

The judgment of step S208 is made to judge whether the accessory mounted on (connected to) the camera 100 is the adapter 160 (a predetermined adapter). As opposed to the adapter 160 that is configured to provide the contact unit 102 with voltages of the predetermined polarities, an interchangeable lens that includes the lens mount B and supports the first communication (not shown) is configured to provide the contact unit 102 with voltages of polarities different from the predetermined polarities. Furthermore, there may be an accessory connectable to the camera 100 other than the adapter 160 and an interchangeable lens that includes the lens mount B, and such an accessory (a predetermined accessory) is also configured to provide the contact unit 102 with voltages of polarities different from the predetermined polarities. Therefore, based on the fact that the polarities detected in step S207 are the predetermined polarities, the camera control unit 104 can judge that the respective accessory mounted on the camera 100 is the adapter 160 among a plurality of accessories mountable on the camera 100.

In the example of FIG. 1, the predetermined polarities are L, L, and H for the three respective terminals included in the contact unit 102, from the top. However, the predetermined polarities are not limited to this. Also, the criterion for judgment of voltages in step S208 is not limited to polarities. In a more generalized explanation, the camera control unit 104 can cause processing to proceed to step S209 in a case where a detected voltage of the contact unit 102 satisfies a first condition, and cause processing to proceed to step S212 in a case where the detected voltage of the contact unit 102 does not satisfy the first condition. The judgment of whether the detected polarities are the predetermined polarities as shown in FIG. 2, is an example of the judgment of whether the detected voltage of the contact unit 102 satisfies the first condition. Also, as stated earlier, it is sufficient for the contact unit 102 to include one or more terminals. Therefore, it can be said that the detected voltage of the contact unit 102 satisfies the first condition in a case where each of the one or more voltages that have been detected respectively in the one or more terminals satisfies a corresponding, respective condition.

An respective condition may be a condition based on polarity, or may be a condition based on a specific voltage value or a voltage range. In the example of FIG. 1, the contact unit 102 includes three terminals, and the respective conditions that correspond to the terminals are L, L, and H, respectively, from the top. As another example, the contact unit 102 may include one terminal, and a respective condition may be a voltage range of 2V to 3V. In this case, the contact unit 162 of the adapter 160 includes one terminal, and the adapter 160 is configured to provide one terminal in the contact unit 102 with a voltage in the range of 2V to 3V via one terminal in the contact unit 162.

In step S209, the second communication unit 106 inside the camera control unit 104 performs initial communication of the second communication. A communication method of the second communication unit 106 is a communication method intended for communication with an interchangeable lens that includes the lens mount D. In the initial communication of the second communication, too, the camera control unit 104 can distinguish the type of the mounted interchangeable lens by obtaining initial information, a lens ID, and the like of the mounted interchangeable lens, similarly to the initial communication of the first communication.

In step S210, the camera control unit 104 judges whether the initial communication of the second communication has succeeded. In a case where the initial communication of the second communication has succeeded, processing proceeds to step S211; otherwise, processing proceeds to step S212. In the example of FIG. 1, as the interchangeable lens 150 that supports the second communication is connected to the camera 100 via the adapter 160, it is judged that the initial communication of the second communication has succeeded.

In step S211, the camera control unit 104 recognizes that the mounted interchangeable lens is a lens that supports the second communication. Thereafter, the startup processing ends, and the operations of the camera control unit 104 transition to a normal sequence of the second communication.

In step S212, the camera control unit 104 recognizes that the mounted interchangeable lens is a lens that does not support the first communication and the second communication. In this case, the camera control unit 104 determines that an interchangeable lens supported by the camera 100 has not been mounted, and ends the startup processing. For example, in a case where it has been judged that the polarities are not the predetermined polarities in step S208, processing transitions from step S208 to step S212. Therefore, it can be said that the camera control unit 104 performs control to refrain from starting the second communication in a case where the detected polarities are not the predetermined polarities (in a case where the detected voltage of the contact unit 102 does not satisfy the first condition).

### <Summary of First Embodiment>

As described above, according to the first embodiment, the camera system includes the camera 100 that supports the first communication and the second communication, the adapter 160, and the interchangeable lens 150 that supports the second communication.

The camera 100 includes the contact unit 101 and the contact unit 102 that are used to connect each of a plurality of accessories, including the adapter 160, to the camera 100. Also, the camera 100 includes the first communication unit 105 that performs the first communication via the contact unit 101, and the second communication unit 106 that performs the second communication via the contact unit 101. Furthermore, the camera 100 performs control to detect a voltage of the contact unit 102 after a respective accessory among the plurality of accessories has been connected, and to start the second communication in a case where the detected voltage satisfies the first condition.

The adapter 160 is configured to, when connected to the camera 100, provide the contact unit 102 with a voltage that satisfies the first condition. Also, the adapter 160 includes the contact unit 163 that is used to connect the interchangeable lens 150, which supports the second communication, to the adapter 160, and a communication path that causes the second communication from the camera 100 to reach the contact unit 163.

The interchangeable lens 150 does not support the first communication, unlike an interchangeable lens that includes the lens mount B. Therefore, in the camera system of FIG. 1, the initial communication of the first communication fails in the startup processing sequence of the camera 100. However, based on the fact that the voltage of the contact unit 102 satisfies the first condition, the camera 100 can recognize that the accessory connected to the camera 100 is the adapter 160 to which the interchangeable lens 150 is connectable, and start the second communication.

Therefore, according to the first embodiment, an image capturing apparatus can communicate with an interchangeable lens in a situation where the interchangeable lens, which does not support the communication standard between an image capturing apparatus and an interchangeable lens that is for an interchangeable lens directly mountable on an image capturing apparatus and which supports a different communication standard, is mounted on the image capturing apparatus via an adapter.

Also, in the embodiment, the camera 100 controls whether to start the second communication based on a voltage of the contact unit 102. Therefore, it is sufficient that the adapter 160 be configured to provide the contact unit 102 with a voltage that satisfies the first condition, and the adapter 160 is required to neither perform special control for causing the camera 100 to start the second communication, nor include a function of communicating with the camera 100. Therefore, according to the embodiment, complication of the configuration of the adapter 160 can be suppressed.

### Second Embodiment

The first embodiment has been described in relation to a case where the adapter 160 includes the power source unit 164. In contrast, a second embodiment will be described in relation to a case where the adapter 160 does not include the power source unit 164. Note that in the description of the second embodiment, reference signs that are the same as those of the first embodiment are assigned to the configurations and processing that are the same as or similar to those of the first embodiment. The following mainly describes the differences from the first embodiment.

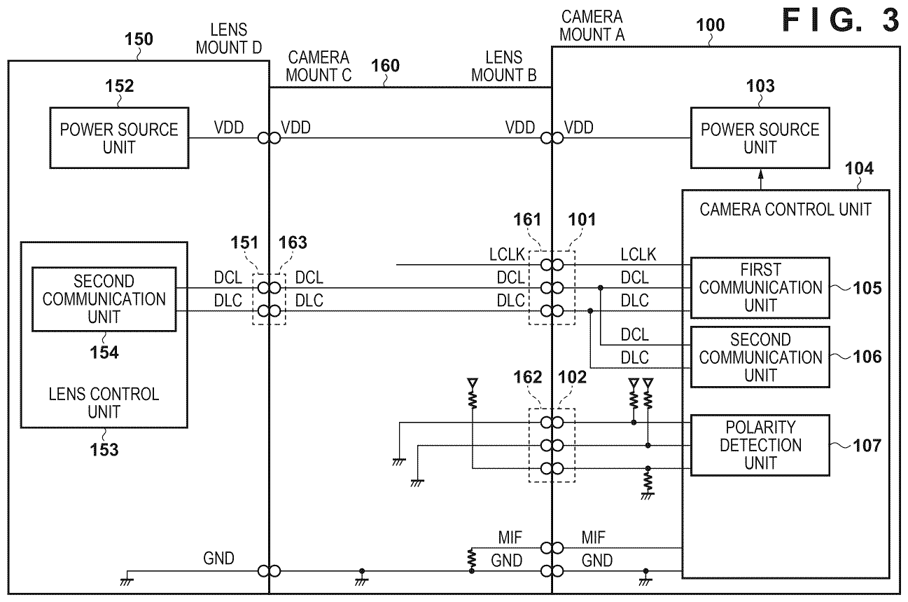

FIG. 3 is a block diagram showing a configuration of a camera system according to the second embodiment. In the camera system of FIG. 3, unlike the camera system of FIG. 1, the adapter 160 does not include the power source unit 164. The adapter 160 is configured to supply power supplied from the power source unit 103 to the interchangeable lens 150 without transforming the voltage thereof. Furthermore, a line that transmits a control signal from the camera control unit 104 to the power source unit 103 is added. In the embodiment, it is expected that the power source unit 103 directly supplies voltage compatible with the interchangeable lens 150.

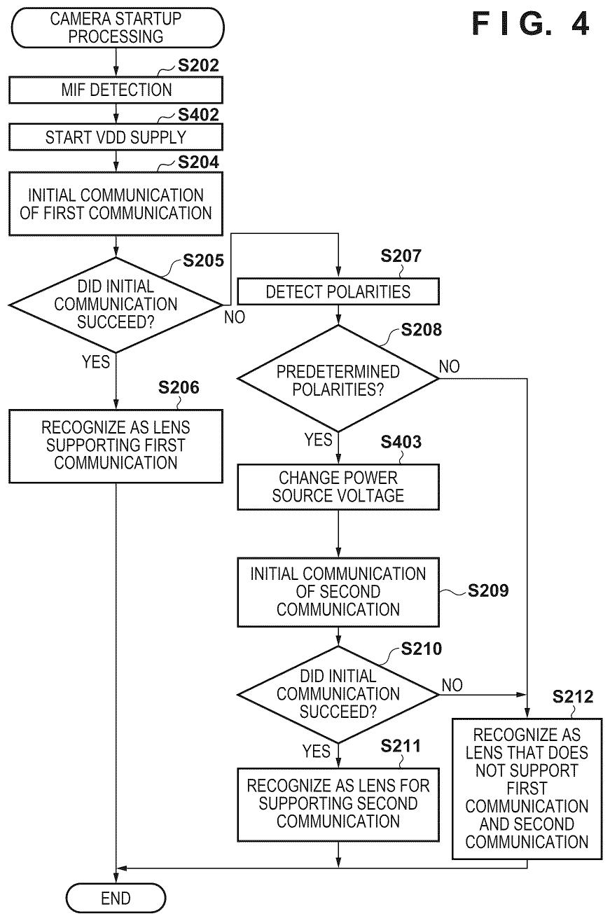

FIG. 4 is a flowchart of startup processing of the camera 100 according to the second embodiment. When a user has operated a power source button (not shown) of the camera 100, a power source of the camera 100 is turned ON, and the power source unit 103 starts to supply an operating power; consequently, the camera control unit 104 starts the startup processing of the flowchart. It is assumed that processing of each step in the flowchart is realized by the camera control unit 104 executing a program stored in a ROM (not shown), unless specifically stated otherwise.

In step S402, the camera control unit 104 controls the power source unit 103 to supply power of a first voltage to the adapter 160. The first voltage is a voltage supported by an interchangeable lens that includes the lens mount B (not shown).

In step S403, the camera control unit 104 controls the power source unit 103 to supply power of a second voltage to the adapter 160. The second voltage is a voltage supported by the interchangeable lens 150 that includes the lens mount D, and is higher than the first voltage. Consequently, the supply of power necessary for the operations of the interchangeable lens 150 is started; this enables the second communication unit 154 inside the lens control unit 153 of the interchangeable lens 150 to perform the second communication.

In this way, in the embodiment, until it is judged in step S208 that the polarities detected in step S207 are the predetermined polarities, the first voltage (the voltage supported by an interchangeable lens that includes the lens mount B) that is lower than the second voltage is supplied from the VDD terminal of the camera 100. Should the second voltage be supplied from the VDD terminal of the camera 100 at the time of step S402, in a case where an interchangeable lens that includes the lens mount B has been mounted on the camera 100, a voltage higher than the voltage supported by the interchangeable lens that includes the lens mount B is supplied to this interchangeable lens. As a result, there is a possibility that a failure occurs in this interchangeable lens. In the embodiment, control to change a power source voltage to the second voltage is performed after it has been judged that the detected polarities are the predetermined polarities, thereby suppressing a possibility that a voltage higher than the voltage supported by an interchangeable lens that includes the lens mount B is supplied to this interchangeable lens.

### Third Embodiment

A third embodiment will be described in relation to a configuration in which the camera mount A of the camera 100 and the lens mount B of the adapter 160 include a TYPE terminal. Note that in the description of the third embodiment, reference signs that are the same as those of the first and second embodiments are assigned to the configurations and processing that are the same as or similar to those of the first and second embodiments. The following mainly describes the differences from the first and second embodiments.

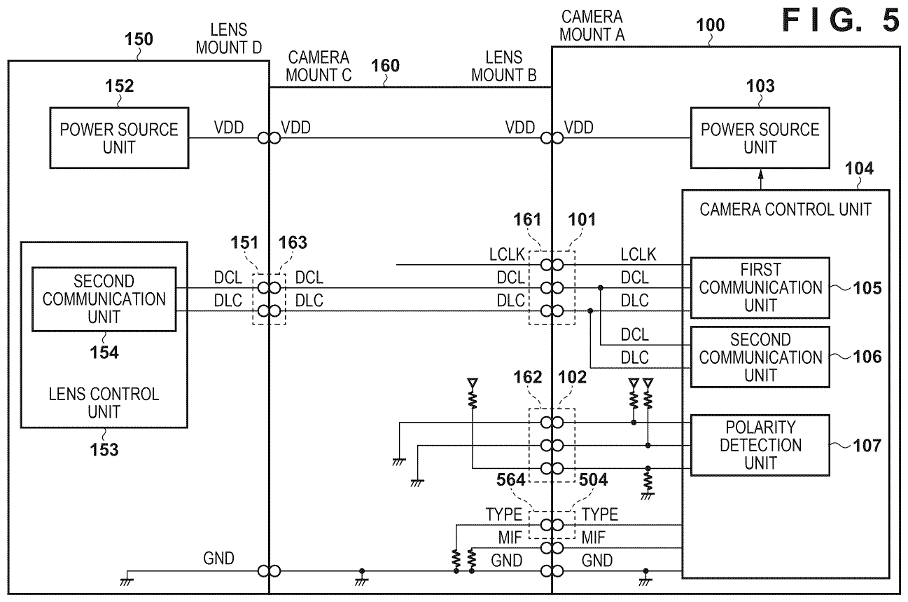

FIG. 5 is a block diagram showing a configuration of a camera system according to the third embodiment. In the camera system of FIG. 5, unlike the camera system of FIG. 3, the camera mount A of the camera 100 includes a contact unit 504 (fourth contact unit) that includes a TYPE terminal, and the lens mount B of the adapter 160 includes a contact unit 564 (fourth contact unit) that includes a TYPE terminal.

The contact unit 504 (TYPE terminal) is a contact unit (terminal) for distinguishing a type of a camera accessory mounted on the camera 100. The camera 100 detects a voltage of the TYPE terminal, and distinguishes the accessory to be an interchangeable lens that includes the lens mount B (not shown) in a case where the voltage falls in a predetermined range 1. Also, the camera 100 distinguishes the accessory to be an adapter that includes the lens mount B in a case where the voltage falls in a predetermined range 2. Furthermore, the camera 100 distinguishes an occurrence of an error in a case where the voltage falls in neither the predetermined range 1 nor the predetermined range 2. The TYPE terminal of the interchangeable lens that has the lens mount B (not shown) is pulled-down and connected to the GND terminal via a resistor so that the voltage falls in the predetermined range 1. The TYPE terminal of the adapter 160 is pulled down and connected to the GND terminal via a resistor so that the voltage falls in the predetermined range 2.

Note, there is a possibility that adapters that have various different specifications exist as adapters that include the lens mount B. Therefore, even in a case where the voltage of the TYPE terminal falls in the predetermined range 2, the mounted adapter is not necessarily the adapter 160 of the embodiment (the adapter on which the interchangeable lens 150 that supports the second communication is mountable).

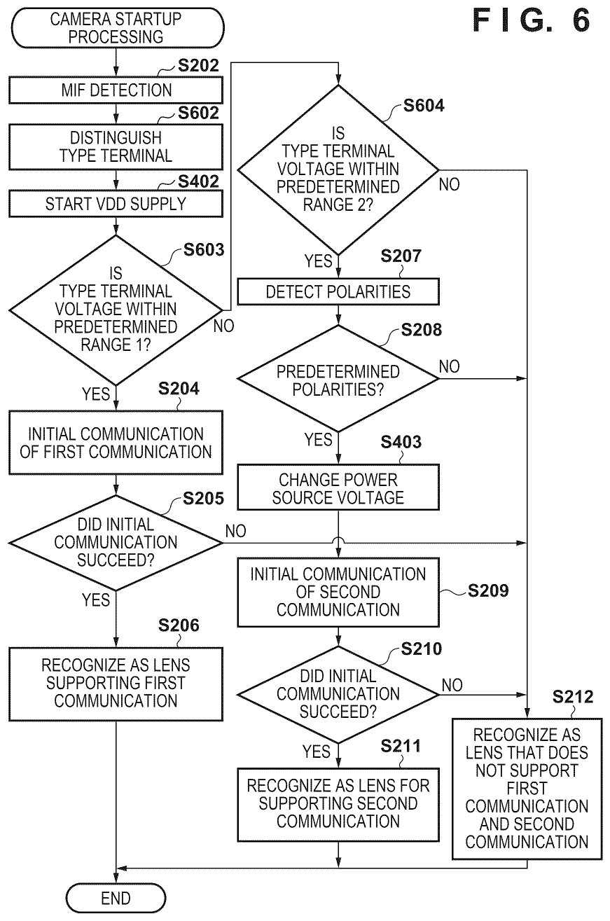

FIG. 6 is a flowchart of startup processing of the camera 100 according to the third embodiment. When a user has operated a power source button (not shown) of the camera 100, a power source of the camera 100 is turned ON, and the power source unit 103 starts to supply an operating power; consequently, the camera control unit 104 starts the startup processing of the flowchart. It is assumed that processing of each step in the flowchart is realized by the camera control unit 104 executing a program stored in a ROM (not shown), unless specifically stated otherwise.

In step S602, the camera control unit 104 distinguishes the TYPE terminal. The camera control unit 104 distinguishes the type of the camera accessory in accordance with a voltage level of the TYPE terminal.

In step S603, the camera control unit 104 judges whether the voltage of the TYPE terminal falls in the predetermined range 1. In a case where the voltage of the TYPE terminal falls in the predetermined range 1, processing proceeds to step S204; otherwise, processing proceeds to step S604.

In step S604, the camera control unit 104 judges whether the voltage of the TYPE terminal falls in the predetermined range 2. In a case where the voltage of the TYPE terminal falls in the predetermined range 2, processing proceeds to step S207; otherwise, processing proceeds to step S212.

Note, although processing of step S205 of FIG. 6 is similar to step S205 of FIG. 2, the destination of transition of processing in a case where the initial communication of the first communication has failed is step S212, rather than step S207, in the embodiment.

In this way, in the embodiment, the camera 100 further includes the contact unit 504 that is used, together with the contact unit 101 and the contact unit 102, to connect each of a plurality of accessories to the camera 100. The camera control unit 104 performs control to start the first communication in a case where a detected voltage of the contact unit 504 (TYPE terminal) falls in the predetermined range 1 (satisfies a second condition). Also, the camera control unit 104 performs control to start the second communication, without starting the first communication, in a case where the detected voltage of the contact unit 504 (TYPE terminal) does not fall in the predetermined range 1 (does not satisfy the second condition) and the detected voltage of the contact unit 102 satisfies the first condition.

Furthermore, in a case where the voltage of the TYPE terminal falls in neither the predetermined range 1 nor the predetermined range 2, the camera control unit 104 can recognize that a mounted interchangeable lens does not support the first communication and the second communication without making a judgment related to the polarities of the contact unit 102. Similarly, in a case where the voltage of the TYPE terminal falls in the predetermined range 1 and the initial communication of the first communication has failed, the camera control unit 104 can recognize that a mounted interchangeable lens does not support the first communication and the second communication without making a judgment related to the polarities of the contact unit 102.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-153334, filed Sep. 5, 2024, which is hereby incorporated by reference herein in its entirety.

What is claimed is:

1. An apparatus, comprising:
a first contact unit and a second contact unit for use in connecting each of a plurality of accessories, including a predetermined adapter, to the apparatus; and
at least one processor; and
at least one memory coupled to the at least one processor storing instructions that, when executed by the at least one processor, cause the at least one processor to functions as:
a first communication unit configured to perform first communication via the first contact unit;
a second communication unit configured to perform second communication via the first contact unit;
a detection unit configured to detect a voltage of the second contact unit after a respective accessory among the plurality of accessories has been connected; and
a control unit configured to perform control to start the second communication in a case where the detected voltage of the second contact unit satisfies a first condition,
wherein
the predetermined adapter is configured to, when connected to the apparatus, provide the second contact unit with a voltage that satisfies the first condition,
the predetermined adapter includes a third contact unit for use in connecting a predetermined interchangeable lens, which supports the second communication, to the predetermined adapter, and
the predetermined adapter includes a communication path that causes the second communication from the apparatus to reach the third contact unit.

2. The apparatus according to claim 1, wherein
the plurality of accessories include a predetermined accessory,
the predetermined accessory is configured to, when connected to the apparatus, provide the second contact unit with a voltage that does not satisfy the first condition, and
the control unit performs control to refrain from starting the second communication in a case where the detected voltage of the second contact unit does not satisfy the first condition.

3. The apparatus according to claim 1, wherein
the control unit
performs control to start the first communication after the respective accessory has been connected, and
performs control to start the second communication in a case where the first communication has failed and the detected voltage of the second contact unit satisfies the first condition.

4. The apparatus according to claim 1, wherein the at least one processor further functions as
a fourth contact unit for use in, together with the first contact unit and the second contact unit, connecting each of the plurality of accessories to the apparatus, and
wherein the control unit
detects a voltage of the fourth contact unit after the respective accessory has been connected;
performs control to start the first communication in a case where the detected voltage of the fourth contact unit satisfies a second condition, and
performs control to start the second communication, without starting the first communication, in a case where the detected voltage of the fourth contact unit does not satisfy the second condition and the detected voltage of the second contact unit satisfies the first condition.

5. The apparatus according to claim 3, wherein
the plurality of accessories include an interchangeable lens that supports the first communication, and
the interchangeable lens that supports the first communication is configured to, when connected to the apparatus, provide the second contact unit with a voltage that does not satisfy the first condition.

6. The apparatus according to claim 1, further comprising
a power source unit,
wherein the control unit
performs control to supply power of a first voltage from the power source unit to the respective accessory after the respective accessory has been connected, and
performs control to change a voltage of power supplied to the respective accessory from the first voltage to a second voltage higher than the first voltage in a case where the detected voltage of the second contact unit satisfies the first condition.

7. The apparatus according to claim 6, wherein
the predetermined adapter is configured to supply power supplied from the power source unit to the predetermined interchangeable lens without transforming a voltage thereof.

8. The apparatus according to claim 1, wherein
the second contact unit includes one or more terminals, and
the detected voltage of the second contact unit satisfies the first condition in a case where each of one or more voltages that have been detected respectively in the one or more terminals satisfies a corresponding respective condition.

9. A system, comprising:
the apparatus according to claim 1; and
the predetermined adapter.

10. An adapter connectable to an apparatus,
wherein the apparatus comprises:
a first contact unit;
a second contact unit; and
at least one processor; and
at least one memory coupled to the at least one processor storing instructions that, when executed by the at least one processor, cause the at least one processor to function as:
a first communication unit configured to perform first communication via the first contact unit; and
a second communication unit configured to perform second communication via the first contact unit,
the adapter comprising:
a first contact unit configured to be connected to the first contact unit of the apparatus when the adapter has been connected to the apparatus;
a second contact unit configured to be connected to the second contact unit of the apparatus when the adapter has been connected to the apparatus;
a third contact unit for use in connecting a predetermined interchangeable lens, which supports the second communication, to the adapter; and
a communication path configured to cause the second communication from the apparatus to reach the third contact unit,
wherein the adapter is configured to, when connected to the apparatus, provide the second contact unit of the apparatus with a voltage that satisfies a first condition via the second contact unit of the adapter.

11. A method executed by an apparatus,
wherein the apparatus comprises:
a first contact unit and a second contact unit for use in connecting each of a plurality of accessories, including a predetermined adapter, to the apparatus; and
at least one processor; and
at least one memory coupled to the at least one processor storing instructions that, when executed by the at least one processor, cause the at least one processor to function as:
a first communication unit configured to perform first communication via the first contact unit; and
a second communication unit configured to perform second communication via the first contact unit,
the method comprising:
detecting a voltage of the second contact unit after a respective accessory among the plurality of accessories has been connected; and
performing control to start the second communication in a case where the detected voltage of the second contact unit satisfies a first condition,
wherein
the predetermined adapter is configured to, when connected to the apparatus, provide the second contact unit with a voltage that satisfies the first condition,
the predetermined adapter includes a third contact unit for use in connecting a predetermined interchangeable lens, which supports the second communication, to the predetermined adapter, and
the predetermined adapter includes a communication path that causes the second communication from the apparatus to reach the third contact unit.

12. The method according to claim 11 further comprising:
performing control to refrain from starting the second communication in a case where the detected voltage of the second contact unit does not satisfy the first condition
wherein
the plurality of accessories include a predetermined accessory,
the predetermined accessory is configured to, when connected to the apparatus, provide the second contact unit with a voltage that does not satisfy the first condition.

13. The method according to claim 11, further comprising:
performing control to start the first communication after the respective accessory has been connected, and
performing control to start the second communication in a case where the first communication has failed and the detected voltage of the second contact unit satisfies the first condition.

14. The method according to claim 11, wherein the apparatus further comprises a fourth contact unit for use in, together with the first contact unit and the second contact unit, connecting each of the plurality of accessories to the apparatus, and
the method further comprising:
detecting a voltage of the fourth contact unit after the respective accessory has been connected;
performing control to start the first communication in a case where the detected voltage of the fourth contact unit satisfies a second condition, and
performing control to start the second communication, without starting the first communication, in a case where the detected voltage of the fourth contact unit does not satisfy the second condition and the detected voltage of the second contact unit satisfies the first condition.

15. The method according to claim 11, wherein the apparatus further comprises a power source unit,
the method further comprising:
performing control to supply power of a first voltage from the power source unit to the respective accessory after the respective accessory has been connected, and
performing control to change a voltage of power supplied to the respective accessory from the first voltage to a second voltage higher than the first voltage in a case where the detected voltage of the second contact unit satisfies the first condition.

16. A non-transitory computer-readable storage medium which stores a program for causing an apparatus to execute a method,
wherein the apparatus comprises a first contact unit and a second contact unit for use in connecting each of a plurality of accessories, including a predetermined adapter, to the apparatus,
the method comprising:
performing first communication via the first contact unit; and
performing second communication via the first contact unit,
detecting a voltage of the second contact unit after a respective accessory among the plurality of accessories has been connected; and
performing control to start the second communication in a case where the detected voltage of the second contact unit satisfies a first condition,
wherein
the predetermined adapter is configured to, when connected to the apparatus, provide the second contact unit with a voltage that satisfies the first condition,
the predetermined adapter includes a third contact unit for use in connecting a predetermined interchangeable lens, which supports the second communication, to the predetermined adapter, and
the predetermined adapter includes a communication path that causes the second communication from the apparatus to reach the third contact unit.

17. The non-transitory computer-readable storage medium according to claim 16 further comprising:
performing control to refrain from starting the second communication in a case where the detected voltage of the second contact unit does not satisfy the first condition
wherein
the plurality of accessories include a predetermined accessory,
the predetermined accessory is configured to, when connected to the apparatus, provide the second contact unit with a voltage that does not satisfy the first condition.

18. The non-transitory computer-readable storage medium according to claim 16, further comprising:
performing control to start the first communication after the respective accessory has been connected, and
performing control to start the second communication in a case where the first communication has failed and the detected voltage of the second contact unit satisfies the first condition.

19. The non-transitory computer-readable storage medium according to claim 16, wherein the apparatus further comprises a fourth contact unit for use in, together with the first contact unit and the second contact unit, connecting each of the plurality of accessories to the apparatus, and
the method further comprising:
detecting a voltage of the fourth contact unit after the respective accessory has been connected;
performing control to start the first communication in a case where the detected voltage of the fourth contact unit satisfies a second condition, and
performing control to start the second communication, without starting the first communication, in a case where the detected voltage of the fourth contact unit does not satisfy the second condition and the detected voltage of the second contact unit satisfies the first condition.

20. The non-transitory computer-readable storage medium according to claim 16, wherein the apparatus further comprises a power source unit,
the method further comprising:
performing control to supply power of a first voltage from the power source unit to the respective accessory after the respective accessory has been connected, and
performing control to change a voltage of power supplied to the respective accessory from the first voltage to a second voltage higher than the first voltage in a case where the detected voltage of the second contact unit satisfies the first condition.
